(19) United States
(12) Patent Application Publication
(10) Pub. No.: US 2006/0269336 A1
(43) Pub. Date: Nov. 30, 2006

(54) Image printing apparatus

(76) Inventors: Satoshi Nishida, Tokyo (JP); Shigetaka Kurosu, Tokyo (JP); Kazuteru Ishizuka, Tokyo (JP)

Correspondence Address: CANTOR COLBURN, LLP, 55 GRIFFIN ROAD SOUTH, BLOOMFIELD, CT, 06002, US

(21) Appl. No.: 11/361,818

(22) Filed: Feb. 24, 2006

(30) Foreign Application Priority Data
May 25, 2005 (JP) 2005-152240

(51) Int. Cl. G03G 15/00; B41J 2/01

(52) U.S. Cl. 399/364; 347/101

(57) ABSTRACT

An image printing apparatus for performing duplex image printing to a transferring sheet, comprising: an image printing section for printing an image on the transferring sheet by making use of a toner including wax; a fixing section for fixing the image printed on the transferring sheet; and a transporting member for changing a moving direction of the transferring sheet, wherein the transporting member has at least a curvature and smooth surface which contacts uniformly the transferring sheet with the fixed image. The transporting member is formed with a plurality of convexity parts arranged in oblique, X-, or V-shapes.

### CROSS-REFERENCE TO RELATED APPLICATION

This application makes reference to, incorporation the same herein, and claims all benefits accruing under 35 U.S.C. § 119 from an application for Image Printing Apparatus earlier filed in the Japanese Patent Office on May 25, 2005, and there duly assigned No. 2005-152240.

### BACKGROUND OF THE INVENTION

1. Field of the Invention

The present invention relates to an image printing apparatus in which when performing duplex image printing using a toner including wax, stripes formed by a hollow-stroke line image and image nonuniformities in the printed image are prevented.

2. Description of the Related Art

Conventionally, in printing an image on a transfer medium such as a transferring sheet by an image printing apparatus, the transferring sheet is sufficiently heated when it is to be subjected to a fixing process by a fixing device. The transferring sheet is not cooled readily even after it passes the nip portion of the fixing device as well. When the transferring sheet passes through transferring sheet convey rollers arranged immediately after the nip, the molten toner on the image surface is pressurized by the convey rollers. Consequently, a roller mark is formed on the image surface or the image surface is scraped by rubbing to degrade the image quality particularly due to the following reason. Toner dispersed with a release agent such as wax is used instead of supplying a release medium such as silicone oil to the surface of the heat roller of the fixing device, and the release agent such as wax is allowed to seep out into and be present in only the toner image portion during fixing, so that the toner adheres to the transferring sheet better and additional writing after printing is allowed more. Above all, in a full-color image or the like, the surface of the toner image is covered with a wax layer, and accordingly an image quality damage occurs conspicuously.

In view of this situation, each of Japanese Unexamined Patent Publication Nos. 2001-183880 and 2003-20149 (patent references 1 and 2) discloses an image printing apparatus comprising a fixing device which fixes an unfixed toner image on a transfer medium such as a transferring sheet and a pair of convey rollers which sandwich and convey the transferring sheet fixed by the fixing device. In this image printing apparatus, of the pair of convey rollers which are the closest downstream to the nip portion of the fixing device, the roller located on the toner image side of the transferring sheet has a sponge-like surface, and the roller located on the opposite side to the toner image of the transferring sheet is a rigid roller. In patent reference 1, the rollers of the pair press each other. In patent reference 2, the rollers of the pair are arranged in noncontact with each other at a predetermined gap.

These attempts are aimed at preventing degradation in image quality caused by the roller mark or scraping due to rubbing described above. While patent reference 2 is said to have a larger effect than patent reference 1, its effect is not yet sufficient. The phenomenon of image quality degradation caused by the roller mark or scraping due to rubbing occurs not only in single-side image printing but also in duplex image printing.

### SUMMARY OF THE INVENTION

The present invention can provide an image printing apparatus that can solve more strongly the problem of image quality degradation in the prior art which is caused by a roller mark or scraping due to rubbing.

If a roller mark or scraping due to rubbing is formed on an obverse surface image by convey rollers during duplex image printing, it changes the transfer performance in image printing on the reverse surface to appear as stripes or nonuniformities. The present invention can provide an image printing apparatus that can prevent this phenomenon.

According to the first aspect of the present invention, there is provided an image printing apparatus for performing duplex image printing to a transferring sheet comprising an image printing section for printing an image on the transferring sheet by making use of a toner including wax, a fixing section for fixing the image printed on the transferring sheet, and a transporting member for changing a moving direction of the transferring sheet, wherein the transporting member has at least a curvature and smooth surface which contacts uniformly the transferring sheet with the fixed image.

The transporting member is formed with a plurality of convexity parts arranged in oblique, X-, or V-shapes.

With the image printing apparatus according to the above aspect, image quality degradation such as a roller mark or scraping due to rubbing formed on the obverse surface image of the transferring sheet is eliminated, and stripes formed by a hollow-stroke line image and image nonuniformities formed on the image at a corresponding reverse surface position are also eliminated. As a result, a stable high-quality image can be obtained.

The present invention is more specifically described in the following paragraphs by reference to the drawings attached only by way of example.

### BRIEF DESCRIPTION OF THE DRAWINGS

A more complete appreciation of the present invention, and many of the attendants advantages thereof, will become ready apparent as the same becomes better understood by reference to the following detailed description when considered in conjunction with the accompanying drawings in which like reference symbols and reference numerals indicate the same or similar components, wherein

FIG. 1 is a schematic view showing the arrangement of a color image printing apparatus as an embodiment of an image printing apparatus according to the present invention;

FIG. 2 is a perspective view of an example of a delivery switching member used in the present invention;

FIG. 3 is a plan view showing the surface state of a transferring sheet having two surfaces where images are printed with no image nonuniformities;

FIG. 4A is a perspective view of another example of the delivery switching member used in the image printing apparatus of the present invention;

FIG. 4B is a plan view of the guide surface of the delivery switching member shown in FIG. 4A;

FIG. 5 is a perspective view of a delivery switching member used in a conventional image printing apparatus;

FIG. 6 is a plan view of the reverse surface of a transfer member to show stripes and nonuniformities that are formed on the reverse surface image when the transferring sheet is subjected to duplex image printing by the conventional image printing apparatus which uses the delivery switching member shown in FIG. 5;

FIG. 7A is a sectional view taken along a plane including the respective axes of a secondary transfer roller 5A and backup roller 74 to show a state in which secondary transfer is performed on a transferring sheet P;

FIG. 7B is a sectional view showing a state of a toner image in which a toner layer and wax layer after fixing are separate;

FIG. 7C is a sectional view showing a state of a toner image in which a wax layer has a portion scraped by rubbing with a rib or the like on a convey guide path;

FIG. 7D is a plan view of the reverse surface of a transferring sheet, which has the toner image state shown in FIG. 7C on its obverse surface, to show stripes formed on the reverse surface when the reverse surface is subjected to transfer;

FIG. 8 is a graph showing a difference in transfer rate between a portion from which wax has been scraped and a portion from which the wax has not been scraped;

FIG. 9 is a perspective view of still another delivery switching member used in the image printing apparatus of the present invention; and

FIG. 10 is a perspective view of still another delivery switching member used in the image printing apparatus of the present invention.

### DETAILED DESCRIPTION OF THE PREFERRED EMBODIMENTS

Some preferred embodiments of the present invention will be described below with reference to the accompanying drawings. Note that the description of the preferred embodiments does not limit the technical scope of the claims or the meanings of the technical terms. The assertive explanation in the preferred embodiments of the present invention shows the best mode and does not limit the meanings of the technical terms or the technical scope of the present invention.

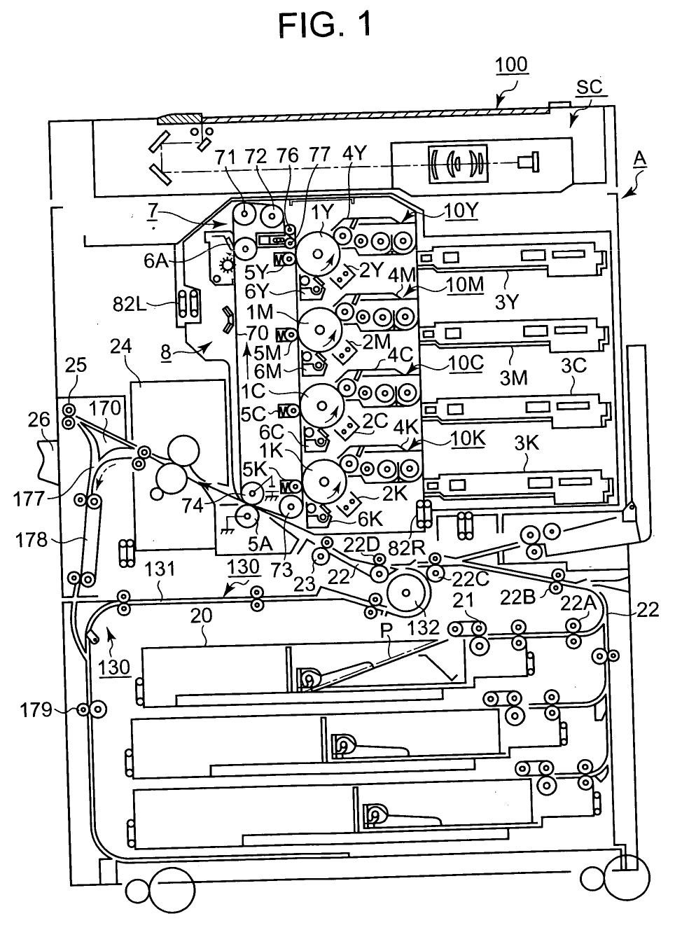

FIG. 1 shows the schematic arrangement of a color image printing apparatus as an embodiment of an image printing apparatus of the present invention.

The image printing apparatus 100, which is referred to as a tandem color image printing apparatus, comprises a plurality of image printing units 10Y, 10M, 10C and 10K, an intermediate transfer body unit 7, a sheet feed and conveying section 21 and a fixing device 24. At the top of the image printing apparatus 100, a document reading device SC is mounted.

The image printing unit 10Y for printing yellow (Y) color images has a photosensitive drum 1Y, a Y-color charging section 2Y arranged around the photosensitive drum 1Y, an exposure section 3Y, a developing section 4Y, a primary transfer roller 5Y as a primary transfer section, and a cleaning section 6Y. The image printing unit 10M for printing magenta (M) color images has a photosensitive drum 1M, a M-color charging section 2M arranged around the photosensitive drum 1M, an exposure section 3M, a developing section 4M, a primary transfer roller 5M as a primary transfer section, and a cleaning section 6M. The image printing unit 10C for printing cyan (C) color images has as a photosensitive drum 1M, a C-color charging section 2C arranged around the photosensitive drum 1C, an exposure section 3C, a developing section 4C, a primary transfer roller 5C as a primary transfer section, and a cleaning section 6C. The image printing unit 10K for printing black (BK) color images has a photosensitive drum 1K, a BK-color charging section 2K arranged around the photosensitive drum 1K, an exposure section 3K, a developing section 4K, a primary transfer roller 5K as a primary transfer section, and a cleaning section 6K.

The intermediate transfer body unit 7 has a semi-conducting, endless-belt-like intermediate transfer body 70 which is wound around and rotatably mounted on a plurality of rollers.

The images of the respective colors formed by image printing units 10Y, 10M, 10C, and 10K are sequentially transferred (primary transfer) onto the endless-belt-like intermediate transfer body 70 rotated by primary transfer rollers 5Y, 5M, 5C, and 5K, respectively, to print a composite color image. A transferring sheet P such as paper or a sheet serving as a transfer medium stored in a feed cassette 20 is fed by a feed portion 21 and conveyed on a convey roller 22 to a secondary transfer roller 5A as a secondary transfer portion by a plurality of intermediate rollers 22A, 22B, 22C, and 22D and a registration roller 23, so that the color images are collectively printed on the transferring sheet P (secondary transfer). The transferring sheet P on which the color images have been transferred is subjected to a fixing process by a fixing device 24 and clamped by delivery rollers 25 so as to be placed on a delivery tray 26 outside the apparatus.

How an image is printed on the first surface as one side of the transferring sheet P has been described. In case of duplex image printing, a delivery switching member 170 switches to open a sheet guide portion 177. Then, the transferring sheet P is conveyed in the direction of a broken-line arrow.

The transferring sheet P is conveyed downward by a convey mechanism 178 and switched back by a sheet reversing portion 179 so the trailing edge of the transferring sheet P becomes a leading edge. The transferring sheet P is then conveyed into a duplex image printing feed unit 130.

The transferring sheet P is moved toward the feed portion 21 through a convey guide 131 provided to the duplex image printing feed unit 130, fed again by a feed roller 132, and guided to the convey roller 22 again.

The transferring sheet P is then conveyed toward the secondary transfer roller 5A. A toner image is transferred onto the second surface which is the reverse surface of the transferring sheet P, and fixed by the fixing device 24. After that, the transferring sheet P is delivered onto the delivery tray 26.

In this manner, the delivery switching member 170 arranged immediately after the fixing device 24 operates to switch between a case of duplex image printing and a case wherein the transferring sheet P is to be subjected to only single-sided copying and delivered after that. In the case of duplex image printing, the transferring sheet P is conveyed to the duplex image printing feed unit 130 so it is copied on its reverse surface.

### First Embodiment

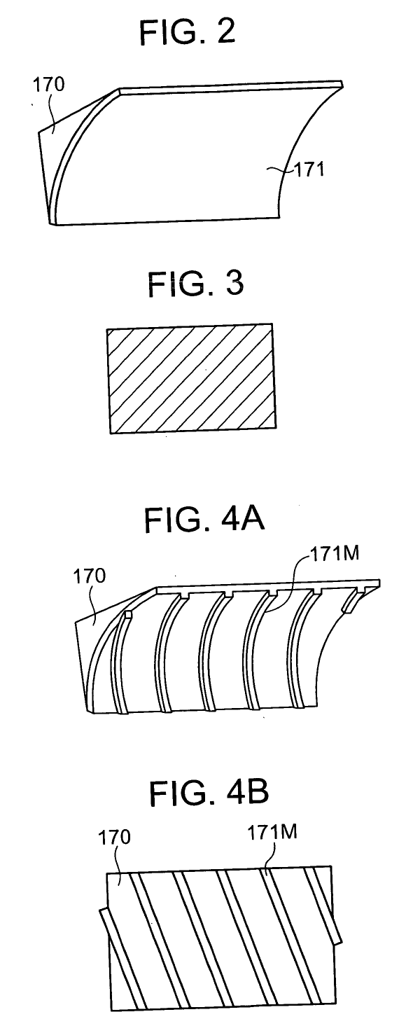

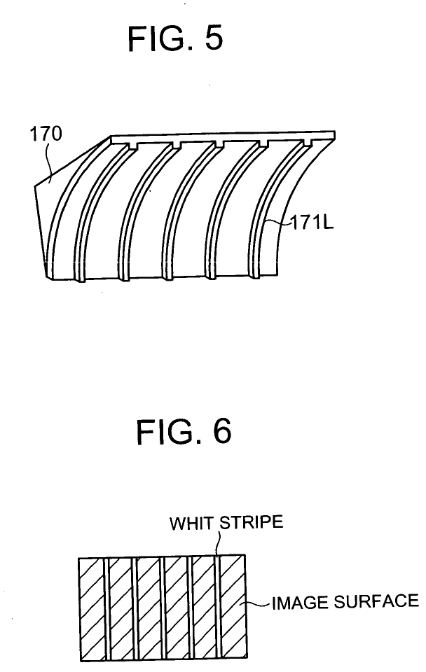

Conventionally, a delivery switching member 170 is employed which uses, as the guide surface, a ribbed guide surface 171L shown in FIG. 5. According to the present invention, the delivery switching member 170 is employed which uses, as the guide surface, a smooth guide surface which forms a cylindrical inner surface shape as shown in FIG. 2.

When the conventional ribbed guide surface 171L is used, as reverse surface copying is performed on the transferring sheet P, white stripes caused by scraping due to rubbing of the image surface, which appear on the obverse side of the transferring sheet, appear on the image surface of the reverse side of the transferring sheet, as shown in FIG. 6. In contrast to this, when the guide surface 171L of the present invention shown in FIG. 2 is mounted, white stripes do not appear at all on the reverse surface of the transferring sheet P, as shown in FIG. 3.

### Other Embodiments

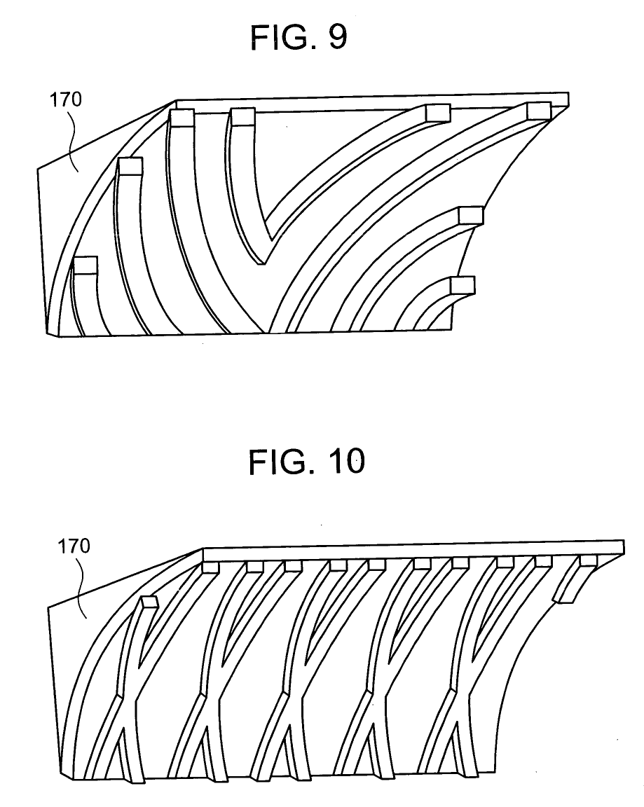

As shown in FIGS. 4A and 4B, in a delivery switching member 170, a guide surface 171M having oblique ribs was disposed obliquely to the traveling direction of the transferring sheet, so that after fixing, the entire toner image on the obverse surface of the transfer evenly came into contact with the guide surface 171M. With this delivery switching member 170, image quality degradation or damages such as a roller mark, scraping due to rubbing, or stripes on the reverse surface image caused by the scraping did not occur in the same manner as in the delivery switching member 170 shown in FIG. 2. When the guide surface was formed to have V ribs (see FIG. 9) or crossing ribs (see FIG. 10), the same effect was obtained.

The effectiveness of the guide surface of the delivery switching member 170 according to the present invention may be due to the following reasons.

The primarily transferred toner image carried by the endless-belt-like intermediate transfer body 70 is sandwiched together with the transferring sheet P conveyed there at a secondary transfer position by the secondary transfer roller 5A and a backup roller 74, and secondarily transferred onto the transferring sheet P.

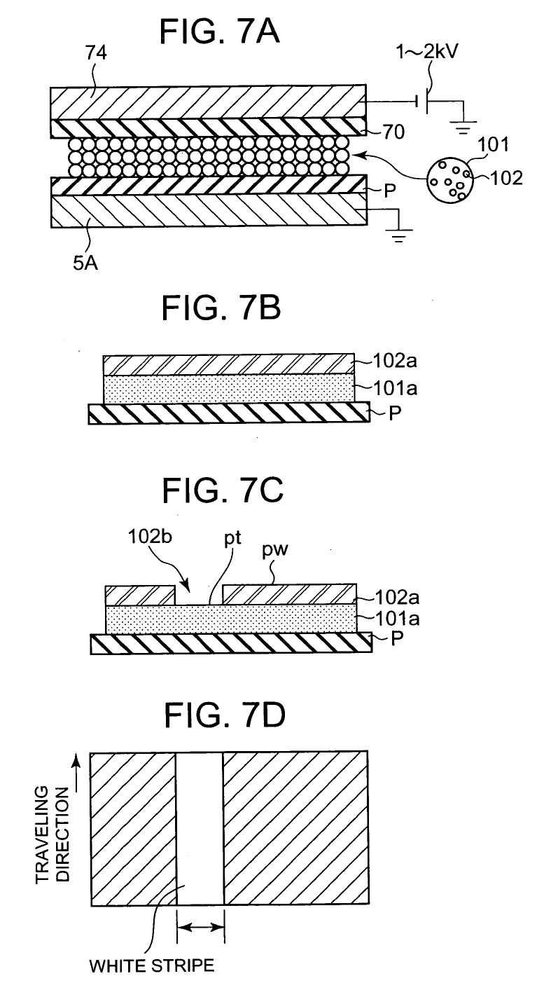

FIG. 7A is a sectional view taken at the position of the secondary transfer along a plane including the respective axes of the secondary transfer roller 5A and backup roller 74. This sectional view shows how toner particles 101 including wax therein are transferred from the endless-belt-like intermediate transfer body 70 to the transferring sheet P. A transfer voltage of −1 kV to −2 kV is applied to the backup roller 74. The secondary transfer roller 5A is grounded.

When secondary transfer is ended and then fixing is completed, the toner particles 101 including wax therein on the transferring sheet separate from wax 102 to form a toner layer 101a and a wax layer 102a on the transferring sheet, as shown in FIG. 7B.

In this state, when the transferring sheet is to be conveyed to the reversing path so as to be subjected to duplex image printing, if the guide surface of the delivery switching member 170 is the conventional ribbed guide surface 171L as shown in FIG. 5, scraped portions 102b are undesirably formed in the wax layer 102a, as shown in FIG. 7C.

With part of the wax layer 102a being scraped, when transfer to the reverse surface as the second surface of the transferring sheet is performed, white stripes are formed on that image printing portion on the reverse side of the transferring sheet which corresponds to the scraped portions 102b, and appear as image nonuniformities.

This phenomenon becomes conspicuous when the amount of wax contained in the toner exceeds 10% by mass, but is allowable in practice unless the amount of wax exceeds 10% by mass. It was confirmed that this phenomenon is more conspicuous in color image printing which uses toners of two or more colors than in monochrome-color image printing.

This inevitably increases the printing rate. Therefore, when white stripes appear, they may stand out accordingly.

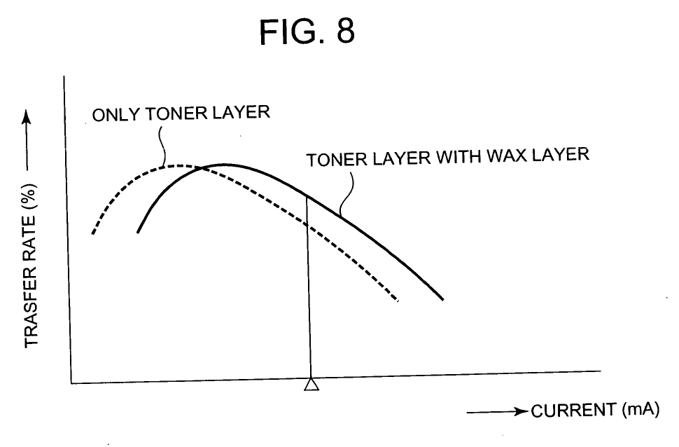

A toner surface resistivity ρt is less than 1×10¹⁷Ω/□ (unit area), and a wax surface resistivity ρw is 1×10¹⁷Ω/□ (unit area) or more. There is a difference, although small, between the two resistivities. As the resistivity change, the current value differs between a surface portion from which the wax has been scraped and a surface portion from which it has not, as shown in FIG. 8. Thus, the transfer rate differs between the toner layer 101a and the wax layer 102a. As a result, image nonuniformities such as white stripes may accordingly appear in the image as described above.

This phenomenon typically occurs immediately after fixing. After that, as the sheet conveyance progresses until transfer, the wax layer 102a is no longer rubbed during conveyance, and white stripes will not appear. In fine, it is significant to quickly cope with scraping due to rubbing at an early stage after fixing.

In this manner, either in single-sided copying or duplex image printing, after a color image is transferred onto the transferring sheet P by the secondary transfer roller 5A serving as a secondary transfer unit, the transferring sheet P is separated from the endless-belt-like intermediate transfer body 70, and the remaining toner on the transfer body 70 is removed by a cleaning portion 6A.

During the image printing process, the primary transfer roller 5K is constantly in tight contact with a photosensitive drum 1K. Other primary transfer rollers 5Y, 5M, and 5C are in tight contact with corresponding photosensitive drums 1Y, 1M, and 1C only during color image printing.

The secondary transfer roller 5A is in tight contact with the endless-belt-like intermediate transfer body 70 only when the transferring sheet P passes by it to be subjected to secondary transfer.

Other additional functions of the image printing apparatus of the present invention will also be described.

A housing 8 can be drawn from an apparatus main body A through support rails 82L and 82R. The housing 8 comprises the image printing units 10Y, 10M, 10C, and 10K, and an endless-belt-like intermediate transfer body unit 7.

The image printing units 10Y, 10M, 10C, and 10K are arranged in tandem with each other in the vertical direction.

The endless-belt-like intermediate transfer body unit 7 is arranged on the left side of the photosensitive drums 1Y, 1M, 1C, and 1K in the state shown in FIG. 1 to be in contact with them.

The endless-belt-like intermediate transfer body unit 7 comprises the pivotal endless-belt-like intermediate transfer body 70, which is looped around rollers 71, 72, 73, 74, 76, and 77, the plurality of primary transfer rollers 5Y, 5M, 5C, and 5K, and the cleaning portion 6A.

When the housing 8 is pulled out, the image printing units 10Y, 10M, 10C, and 10K and the endless-belt-like intermediate transfer body unit 7 are integrally drawn from the main body A.

In this manner, toner images are formed on the photosensitive drums 1Y, 1M, 1C, and 1K by charging, exposure, and development. The toner images of the respective colors are primarily transferred to the endless-belt-like intermediate transfer body 70 to be overlaid on it, and secondarily transferred onto the transferring sheet P collectively. The toner images are fixed on the transferring sheet P by a pressure roller 59 and heat roller 51 of the fixing device 24. After the toner images on the photosensitive drums 1Y, 1M, 1C, and 1K are transferred to the endless-belt-like intermediate transfer body 70, the residual toner which is left on the photosensitive drums 1Y, 1M, 1C, and 1K during transfer is cleaned by cleaning portions 6Y, 6M, 6C, and 6K, respectively. Then, the cycle of charging, exposure, and development is resumed to perform the next image printing.

What is claimed is:

1. An image printing apparatus for performing duplex image printing to a transferring sheet, comprising:
an image printing section for printing an image on the transferring sheet;
a fixing section for fixing the image printed on the transferring sheet; and
a transporting member for changing a moving direction of the transferring sheet,
wherein the transporting member has at least a surface which contacts uniformly the transferring sheet with the fixed image.

2. The image printing apparatus of claim 1, wherein the image printing section for printing the image uses a toner including wax.

3. The image printing apparatus of claim 1, wherein the transporting member has at least a curvature and smooth surface.

4. The image printing apparatus of claim 1, wherein the surface of the transporting member is formed with a plurality of convexity parts which are arranged in oblique direction to the moving direction of the transferring sheet.

5. The image printing apparatus of claim 1, wherein the surface of the transporting member is formed with a plurality of convexity parts which are arranged in X-shapes.

6. The image printing apparatus of claim 1, wherein the surface of the transporting member is formed with a plurality of convexity parts which are arranged in V-shapes.

7. An image printing apparatus for performing duplex image printing to a transferring sheet, comprising:
an image printing section for printing an image on the transferring sheet;
a fixing section for fixing the image printed on the transferring sheet; and
a transporting member for changing a moving direction of the transferring sheet,
wherein the transporting member has at least a curvature and smooth surface which contacts the transferring sheet with the fixed image.

8. The image printing apparatus of claim 7, wherein the image printing section for printing the image uses a toner including wax.

9. An image printing apparatus for performing duplex image printing to a transferring sheet, comprising:
an image printing section for printing an image on the transferring sheet;
a fixing section for fixing the image printed on the transferring sheet; and
a transporting member for changing a moving direction of the transferring sheet,
wherein the transporting member is formed with a plurality of convexity parts which are arranged in oblique direction to the moving direction of the transferring sheet, and wherein the convexity parts contact the transferring sheet with the fixed image.

10. The image printing apparatus of claim 9, wherein the image printing section for printing the image uses a toner including wax.
